(19) United States
(12) Patent Application Publication
(10) Pub. No.: US 2026/0044824 A1
(43) Pub. Date: Feb. 12, 2026

(54) SYSTEM AND METHOD FOR TRACKING ASSETS

(71) Applicant: 9506-6593 QUÉBEC INC., Montréal (Québec) (CA)

(72) Inventors: Marco TRUDEL, Sainte-Aurélie (Québec) (CA); Dean TREISTER, Laguna Hills, CA (US)

(21) Appl. No.: 19/295,453

(22) Filed: Aug. 8, 2025

Related U.S. Application Data
(60) Provisional application No. 63/681,231, filed on Aug. 9, 2024.

(30) Foreign Application Priority Data
Nov. 1, 2024 (CA) 3251747

(51) Int. Cl. G06Q 10/087; G06K 7/10; G06Q 30/0201; G10L 15/22; H04W 4/80

(52) U.S. Cl. CPC G06Q 10/0877; G06Q 30/0201; G10L 15/22; H04W 4/80; G06K 7/10297

(57) ABSTRACT

Systems and methods for tracking assets are disclosed. Each asset is associated with a zone of a site and a stock keeping unit (SKU). Assets have a tag affixed thereto. The tag includes a beacon broadcasting a signal. Gateways in the site receive the signals and determine a signal characteristic for each, extract data encoded in the signals, and transmit the data, the signal characteristic and a time associated with each radio signal to a processing unit. The processing receives the data, the signal characteristics and the times, computes asset locations based on the signal characteristics, process some asset locations and the data associated with a given asset to generate event data, store the event data and the asset locations, and aggregates a subset of the event data related to a subset of the assets associated with a given SKU and to provide business intelligence related to the given SKU.

### CROSS-REFERENCES TO RELATED APPLICATIONS

This application claims the benefit of, and priority to, U.S. Provisional Ser. No. 63/681,231, filed Aug. 9, 2024, and Canadian Patent Application No. 3,251,747, filed Nov. 1, 2024, both of which entitled “SYSTEM AND METHOD FOR TRACKING ASSETS,” the disclosures of which are hereby incorporated by reference in their entirety.

### TECHNICAL FIELD

The technical field relates to asset tracking, and more specifically to systems and methods for tracking sample assets to provide business intelligence.

### BACKGROUND

Merchanding programs are used by merchants to promote certain products, for instance by making physical sample assets available to customers in retail locations. This creates a need for merchants to determine whether these assets are actually displayed and available to customers. This also creates an opportunity for merchants to follow up on leads when physical sample assets are taken by customers.

### SUMMARY

A solution that integrates advanced transmitter technology with computer processing power to capture and analyze data samples with precision and speed is disclosed herein. The system can comprise a network of transmitters affixed to assets, transmitting data packets at regular intervals to local processing units via various wireless communication protocols such as Bluetooth™, Wi-Fi, and RFID. These data packets can contain crucial information regarding asset location and signal strength. Local processing units can analyze this data, and identify patterns and behaviours indicative of specific events. These events can then be transmitted to a global processing unit hosted in the cloud for storage, refinement, and visualization.

In accordance with an aspect, a system for tracking a plurality of assets is provided. The system includes: a plurality of tags, each tag being affixed to one asset from the plurality of assets, wherein each asset is associated with: one zone of a site, and one stock keeping unit (SKU) from a plurality of SKUs, wherein each tag includes: a sensor configured to sense a position of the tag within the site, and a beacon configured to broadcast a signal encoding raw data including at least an identifier associated with the asset and data associated with the sensed position; a plurality of gateways located in the site, each gateway including: a receiver configured to receive the signal, a processor configured to extract the raw data encoded in the signal, and a communication device configured to transmit the raw data; and a local processing unit located at the site, the local processing unit including: a communication device configured to receive the raw data from the plurality of gateways, and an event processor configured to process the raw data received from the plurality of gateways to generate event data, wherein the communication device is further configured to transmit the event data to a global processing unit for aggregating a subset of the event data related to a plurality of assets associated with a given SKU and to provide business intelligence related to the given SKU.

In accordance with another aspect, a method for tracking a plurality of assets is provided. The method includes: periodically transmitting raw data about the assets by tags associated with the assets to a local processing unit; periodically processing the raw data into event data by the local processing unit; transmitting the event data by the local processing unit to a global processing unit; and periodically processing the event data by the global processing unit to produce business intelligence.

In accordance with a further aspect, a system for tracking a plurality of assets is provided. The system includes: a plurality of tags, each asset from the plurality of assets having a tag from the plurality of tags affixed thereto, wherein each asset is associated with: one zone of a site, and one stock keeping unit (SKU) from a plurality of SKUs, wherein each tag from the plurality of tags includes a beacon from a plurality of beacons, the beacon being configured to broadcast from time to time a radio signal encoding raw data, resulting in the plurality of beacons broadcasting a plurality of radio signals, each radio signal encoding the raw data associated with a respective asset from the plurality of assets, the raw data including at least an identifier associated with the respective asset; a plurality of gateways located in the site, each gateway including: a receiver configured to receive the plurality of radio signals and to determine a signal characteristic of each of the plurality of radio signals, a processor configured to extract the raw data encoded in each of the plurality of radio signals, and a first communication device configured to transmit the raw data, the signal characteristic and a time associated with each of the plurality of radio signals; and a processing unit, the processing unit including: a second communication device configured to receive the raw data, the signal characteristic and the associated with each of the plurality of radio signals from the plurality of gateways, an asset locator configured to compute a plurality of asset locations, each asset location being associated with a given asset from the plurality of assets and a given time, based at least on the signal characteristic associated with the given asset received from at least one gateway from the plurality of gateways, an event processor configured to process a subset of the plurality of asset locations and the raw data received from the plurality of gateways associated with a given asset from the plurality of assets to generate event data, a database configured to store the generated event data and the plurality of asset locations, and a business analyzer configured to retrieve the event data from the database, to aggregate a subset of the event data related to a subset of the plurality of assets associated with a given SKU and to provide business intelligence related to the given SKU.

In accordance with yet another aspect, a method for tracking a plurality of assets, each asset from the plurality of assets being associated with one zone of a site and one stock keeping unit (SKU) from a plurality of SKUs, is provided. The method includes: broadcasting from time to time, by a tag from a plurality of tags, each asset from the plurality of assets having a tag from the plurality of tags affixed thereto, a radio signal encoding raw data, resulting in the plurality of tags broadcasting a plurality of radio signals, each radio signal encoding the raw data associated with a respective asset from the plurality of assets, the raw data including at least an identifier associated with the respective asset; receiving, by at least one gateway from a plurality of gateways located in the site, the plurality of radio signals; determining, by the at least one gatewat, a signal characteristic of each of the plurality of radio signals; extracting, by the at least one gateway, the raw data encoded in each of the plurality of radio signals; transmitting, by the at least one gateway, the raw data, the signal characteristic and a time associated with each of the plurality of radio signals; receiving, by a processing unit, the raw data, the signal characteristic and the associated with each of the plurality of radio signals from the plurality of gateways; computing, by the processing unit, a plurality of asset locations, each asset location being associated with a given asset from the plurality of assets and a given time, based at least on the signal characteristic associated with the given asset received from at least one gateway from the plurality of gateways; processing, by the processing unit, a subset of the plurality of asset locations and the raw data received from the plurality of gateways associated with a given asset from the plurality of assets to generate event data; storing, by the processing unit, the generated event data and the plurality of asset locations in a database; and aggregating, by the processing unit, a subset of the event data related to a subset of the plurality of assets associated with a given SKU and to provide business intelligence related to the given SKU.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 is a schematic of a system for tracking a plurality of assets, in accordance with an embodiment.

FIG. 2 is a flowchart of a method for tracking a plurality of assets, in accordance with an embodiment.

FIG. 3 is a flowchart of a method for performing conversations and a checkout/checkin process between a customer and a digital assistant, in accordance with an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The terms “a”, “an” and “one” are defined herein to mean “at least one”, that is, these terms do not exclude a plural number of items, unless stated otherwise.

Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements may be acoustical, mechanical, optical, electrical, thermal, logical, wireless, or any combinations thereof.

One or more systems described herein may be implemented in computer program(s) executed on processing device(s), each comprising at least one processor, a data storage system (including volatile and/or non-volatile memory and/or storage elements), and optionally at least one input and/or output device. “Processing devices” encompass computers, servers and/or specialized electronic devices which receive, process and/or transmit data. As an example, “processing devices” can include processing means, such as microcontrollers, microprocessors, and/or CPUs, or be implemented on FPGAs. For example, and without limitation, a processing device may be a programmable logic unit, a mainframe computer, a server, a personal computer, a cloud-based program or system, a laptop, a personal data assistant, a cellular telephone, a smartphone, a wearable device, a tablet, a video game console or a portable video game device.

Each program is preferably implemented in a high-level programming and/or scripting language, for instance an imperative e.g., procedural or object-oriented, or a declarative e.g., functional or logic, language, to communicate with a computer system. However, a program can be implemented in assembly or machine language if desired. In any case, the language may be a compiled or an interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is of course chosen according to the desired use, whether it should retain instructions, or temporarily store, retain or update data. Steps of the proposed method are implemented as software instructions and algorithms, stored in computer memory and executed by processors.

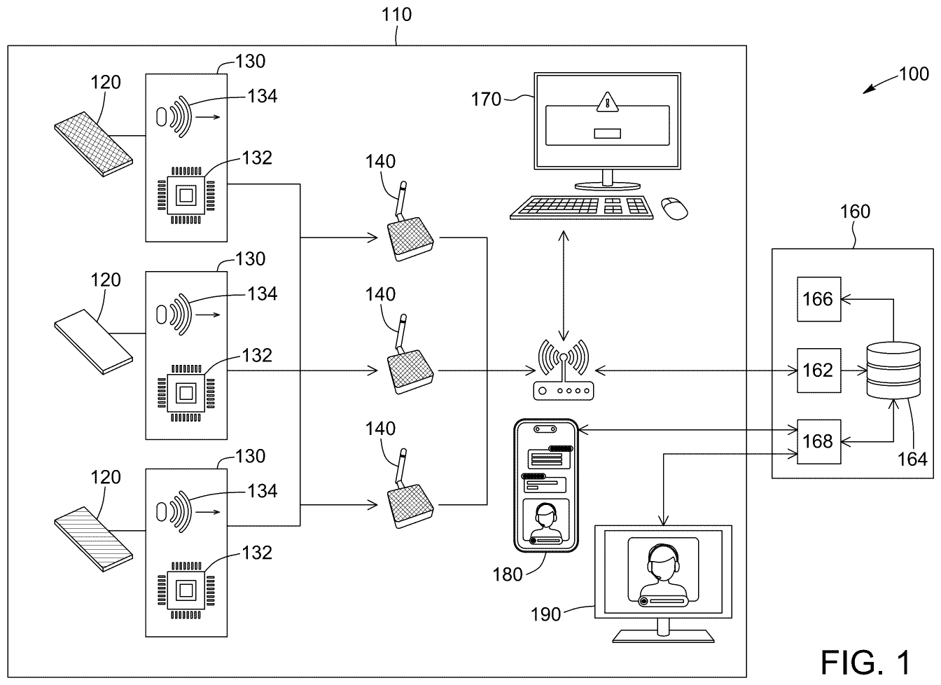

With reference to FIG. 1, an exemplary system 100 for tracking a plurality of assets 120 is shown. Broadly described, the system 100 is deployed to at least one site 110 and includes assets 120, tags 130 affixed to assets, and gateways 140 in communication with tags 130 and a processing unit 160.

Each site 110 can correspond to a designated physical space in which assets 120, such as sample merchandise assets, are on display and available for consumers to evaluate and manipulate. As an example, site 110 can correspond to a retail space, such as a store or a retail showroom. In some embodiments, the site 110 can comprise an indoor environment delimited by walls. The assets 120 can for instance be organized on a display where a consumer may find an asset, pick it up and sometimes move it around the site 110. The site 110 can be physically and/or conceptually divided into a number of zones, e.g., “zones of influence”, with each asset 120 being nominally associated with one zone. As an example, a consumer may want to take a sample of a countertop associated with one zone of a hardware store and carry it to another zone of the store to look at it next to a sample of a wall tile, or take a sample of a wallpaper in one zone and look at it next to a sample of a floor panel in another zone. Information about which assets 120 are being manipulated by consumers and how is valuable business information. Moreover, consumers may move assets 120 around the site 110 and not bring them back to their original location or zone, making it necessary for a staff member to retrieve assets 120, or a consumer could even walk out of the site 110 with an asset, making it necessary for a staff member to replace the asset.

Assets 120 can include for instance a number of objects, pieces of equipment and consumable items provided in various zones of a site 110. As an example, each asset can correspond to a merchandise sample, for instance a piece of carpet, a piece of countertop, a floor, wall or ceiling tile, a floor, wall or ceiling panel, and the site 110 can correspond to a hardware or home improvement store. Each asset can be identified with a unique identifier, e.g., a numeric identifier that is not used for any other assets 120 being tracked in the location 110 or in any location within system 100. In some embodiments, non-unique identifiers are also used to identify a category or type of asset. In some embodiments, identifiers are unique to one category of assets 120 within the system 100, for instance to a specific type and colour of carpet from a specific manufacturer, but shared by all the assets 120 of the identified category. In some embodiments, the non-unique identifiers are stock keeping units (SKUs).

Each asset 120 can be associated with one or more tag(s) 130 that allows tracking the asset 120. As an example, a tag 130 can be affixed, e.g., adhered to an asset 120, either removably or permanently. A tag 130 can include a sensor 132, for instance a movement sensor or a position sensor, configured to sense a position or a movement of the tag 130 and, consequently, of the asset 120 associated with the tag 130. As an example, the sensor 132 can include an inertinal measurement unit (IMU) for example comprising an accelerometer and/or a gyroscope adapted to measure force, angular rate and/or ortientation. A tag 130 can further include at least one transmitter 134 configured to emit a signal encoding information, such as a radio wave modulated to create a radio signal enabling communication at least from the transmitter 134 to suitable receivers in the system 100. As an example, a transmitter 134 can be configured to transmit signals associated with one or more of the Bluetooth™, Wi-Fi and radio-frequency identification (RFID) radio technologies. It can be appreciated that this list is not limitative and that the described system can additionally or alternatively work with other existing or future transmission technologies. In some embodiments, the transmitter 134 operates as a beacon, e.g., a Bluetooth™ Low Energy (BLE) beacon, and broadcasts the radio signal periodically, from time to time, at a configurable, suitable set interval, for instance every second, or every five seconds, and/or when the sensor 132 detects that the asset 120 is in movement or has been moved. Each signal can encode at least one unique identifier allowing for identification of the associated asset 120. In some embodiments, each signal can encode the precise time at which the signal is emitted to a suitable granularity, e.g., in milliseconds. In some embodiment, each signal transmitted by the transmitter 134 encodes readings obtained by the sensor 132. In some embodiments, the signal transmitted or broadcast by transmitter 134 encodes discrete information about one given asset 120 at one given point in time, and this information can therefore be referred to as raw data. In some embodiments, the tag 130 and/or the transmitters 134 are battery-powered, and the set interval can be configured to preserve battery capacity.

The system 100 includes at least one receiver 140, also called gateway, organized as part of a network, adapted to receive signals such as radio signals, in particular signals emitted by the transmitters 134 associated with the assets 120. Therefore, the gateways 140 can be adapted to use the same technologies as the transmitters 134, e.g., Bluetooth™, BLE, Wi-Fi and/or RFID. In some embodiments, the gateways include BLE antennae. In some embodiments, when receiving a radio signal from a transmitter 134, each gateway 140 can be configured to measure at least one characteristic of the signal, in particular at least one characteristic relevant to determining at least an approximate location and/or distance of the asset 120 with respect to the gateway 140, such as angle of arrival (AoA) and/or a received signal strength indicator (RSSI). In some embodiments, the system 100 includes at least three gateways 140 configured to measure signal characteristics adapted to locate transmitters 134 (and therefore assets 120) through triangulation. In some embodiments, time measurements can be used to compute additional characteristics of the signal, e.g., time difference of arrival (TDOA) and/or time of flight (ToF). Information, e.g., raw data, encoded in the signal can be decoded at the receiver 140 then transmitted via a communication device, e.g., a networking adapter such as an Ethernet or Wi-Fi adapter, to the processing unit 160, for instance via a local area network, and/or transmitted encoded to the processing unit 160 by the same means. Signal characteristics can also be transmitted to the processing unit 160. It can be appreciated that the accuracy of the estimated approximate location depends on the density of the network of receivers 140.

In some embodiments, the system 100 can include a local processing unit to perform certain functions of the processing unit 160 locally. The local processing unit can be configured to receive, via a communication device such as a networking adapter, and process information from the network of receivers 140, including for instance encoded or decoded asset-related and/or tag-related raw data transmitted by the transmitters 134 and/or signal characteristics measured by the receivers 140, and to identify different classes of event such as asset on-site arrival, departure, return or motion from the raw data. As can be appreciated, using a local processing unit to perform a part of the processing locally can allow sending data in an aggregated and/or preprocessed form to the processing unit, resulting in using less network bandwidth.

The processing unit 160 (and/or the local processing unit) can implement an asset locator configured to obtain sensor information measured by a sensor 132, e.g., a sensed position of the tag 130 and therefore of the asset 120 encoded in a signal received by one or more gateway 140, and/or the signal characteristics measures by one of more gateways 140, and to determine therefrom a position of the tag 130 and therefore the asset 120. In some embodiments, the locator is aware of zone boundaries within a location 110 and is configured to determine whether an asset 120 associated with a tag 130 for which a position has been determined is located within or outside its associated zone. Upon the locator detecting that an asset 120 is outside of its zone, the processing unit can be configured to transmit a notification including the location of the asset to one or more device 170 operable for instance by staff members of the location 110, including for instance one or more smartphone, tablet, personal computer and/or terminal such as a point of sale terminal, making it possible for a staff member to retrieve the asset 120 and bring it back within its associated zone.

The processing unit 160 (and/or the local processing unit) implements an event processor 162 configured to analyze the raw data received from one or more gateways. Through this analysis, patterns, deviations, and asset-related events can be accurately detected and classified, for instance among the event classes described above, thereby generating event data from the raw data, laying the foundation for actionable insights. The event processor can obtain and store in a database 164, for instance using a database management system such as a relational database management system or a graph database management system, discrete information received at many points of time for each asset 120. A number of discrete information points can be combined to obtain an event. Doing so, the event processor 162, based on the raw data records previously collected and persisted by the event processor 162 and/or in database 164, will be able to log an arrival or return of each asset 120, while a departure will be defined by the lack of records from that very asset the transmitter is attached to for a certain amount of time. On the other hand, a motion will be logged whenever the event processor 162 notices x, y and/or z axis variations from the tag 130. As an example, information received about an asset 120 over many points in time including successive time points t₀, t₁, t₂ and t₃, can indicate that the asset is not moving between t₀ and t₁ or between t₂ and t₃, but is moving between t₁ and t₂, suggesting a movement event starting at t₁ and concluding at t₂. The event processor can generate event data about this event, including for instance information about the asset 120 such as its SKU, a start time and/or position, an end time and/or position, and/or a duration. As another example, information received about an asset 120 over successive time points t₀, t₁, t₂ and t₃, can indicate that the asset is not moving between t₀ and t₁, is moving between t₁ and t₂, is not detected between t₂ and t₃ with a configurable time threshold separating t₂ and t₃, suggesting a signal loss event starting at t₃.

In some embodiments, the system 100 includes customer devices 180, e.g., handheld devices such as smartphones, configured to transmit customer data, including at least a unique identifier associated to the customer, to the gateways 140, to the processing unit 160, and/or to a local processing unit. In some embodiments, customer visits are tracked by identifying patterns in the frames emitted by customer devices within the vicinity by correlating record data such as reported MAC address, time stamp, signal strength and reporting antenna. By analyzing these signals alongside motion data, the event processor 162 can distinguish between asset movement and human activity, further enhancing its ability to detect and classify events accurately. This can allow the event processor 162 to enrich event data by aggregating raw data received from the asset tags 130 and customer data. As an example, this can allow analyzing the interactions of a single customer with a plurality of assets 120. This comprehensive approach to motion event detection ensures robust monitoring of asset behaviour and visitor traffic, enabling informed decision-making and operational optimization across various domains such as the ability to plan the next display's location based on the in-store customer journey to increase specific asset's visibility and potentially increase the conversion rate for this asset. Another possible use case would be with the store staffing while we do get data from the customer visits during business hours, it gives valuable insights over the peak hours during which the store is getting the most customers visits and may require an adjustment in the store staffing and schedule. In some embodiments, customer devices can be provided with an application that exploits communication and/or networking adapters of the customer devices to provide this functionality. The application can also provide additional functionalities, e.g., to operators of location 110, and, to encourage a customer to install the application on their device, digital functionalities that are useful to the customer can also be provided based on the interactions of the customer with assets. As examples, the application can implement a “take-home” sample process, provide direct consumer-retailer interaction via automated lead follow-up and/or support process, and/or provide customer profiles.

The system 100 includes a processing unit 160 configured to aggregate event data received, for instance via a network such as the Internet, from a plurality of gateways 140 and/or local processing units, possibly associated with different locations 110, thereby enriching the event data, for instance to facilitate enhanced interpretation through intuitive data visualization tools. Notably, the processing unit 160 can be configured to reconcile event information with corresponding asset SKUs, optimizing contextual relevance for end users and running trend and geolocated analysis creating a unique opportunity to look at the enriched data from different angles. Doing so, the end user will be able to consume visuals showing the consumer interactions over time per SKU, Brand, Asset type and such granularity of details but also to get views per territory and compare behaviours between them. The processing unit 160 can also be configured to reconciliate the asset location data with the actual in-store layout coordinates so that the SKU asset's location in the store renders on a data visualization pane.

In some embodiments, the processing unit 160 is provided in a cloud platform, e.g., Azure™ or AWS™. Robust data security measures can be integrated into the processing unit 160 to ensure stringent regulation of user access and safeguarding sensitive information from unauthorized disclosure. The processing unit 160 can be provided with a business analyzer 166 configured to provide business intelligence related to an SKU by aggregating all the event data associated with different assets having the same SKU across different locations. As an example, the different locations 110 can correspond to a chain of stores and the processing unit 160 can be operated by the company exploiting the stores to provide business intelligence to the company. As another example, the different locations 110 can correspond to stores belonging to different companies and/or to independent stores and the processing unit 160 can be operated by a product manufacturer and/or distributor providing samples to stores in order to provide business intelligence to the manufacturer and/or distributor. In some embodiments, the business analyzer 166 provides facilities for asset, brand, store and/or organization management. As an example, an automated process to replenish physical sample assets can be implemented. In some embodiments, the business analyzer 166 enhances business intelligence by providing facilities for data visualization and/or business workflow management. As an example, the processing unit 160 can facilitate measuring instant market response to new products. In some embodiments, the business analyzer 166 leverages machine learning to provide facilities for consumer behaviour analysis and/or inventory forecasting. As an example, the business analyzer 166 can be configured to foresee trends and assist the operator in proactively adjusting their merchandizing programs, e.g., based on regional consumers tendencies. As another example, the business analyzer 166 can be configured to measure potential lost sales when a physical asset is not in store and/or to provide automated suggestions on reorganizing physical sample assets.

In some embodiments, the processing unit is configured to maintain a device registry, e.g., a registry of all connected devices such as beacons 134, gateways 140, staff devices 170, customer devices 180 and/or kiosks 190, and to track their status and metadata.

To provide relevant business intelligence, data from multiple locations 110 can be aggregated. Business intelligence can be provided by leveraging models trained to handle raw data. It can be appreciated, though, that raw data is granular and redundant, creating large volumes of data. On the other hand, event data aggregates raw data into a condensed form including only meaningful data. Therefore, processing raw data into event data locally in each location 110 by a local processing unit can allow advantageously reducing the volume of data transferred to the processing unit 160, and therefore the bandwidth required to send the data.

Advantageously, processing unit 160 provides access to the solution information and data on a record level basis based on the user role and organization he or she belongs to promising heightened efficiency, accuracy, and security in managing and analyzing event data, thereby offering substantial advantages in various domains including but not limited to supply chain management, logistics, and business intelligence.

In some embodiments, the processing unit 160 includes a digital assistant module 168 configured to provide assistance to customers and/or system 100 users by enabling text-based and/or speech-based interactions. The digital assistant provided by the digital assistant module 168 can be designed to assist brands, distributors and customers in managing product samples, tracking inventory, and engaging with brands in an intuitive, personalized way. The digital assistant module 168 can leverage different technologies such as image recognition, real-time inventory tracking, and cloud-based data processing to deliver a seamless omni-channel experience. The digital assistant can provide support in retail environments by assisting customers directly in showrooms. Integrated with the database 164, the digital assistant module 168 is aware of all available assets 120 within a location 110 and can for instance guide customers through the showroom experience. In some embodiments, the digital embodiment can adopt a brand's tone, style and/or voice, e.g., formal, conversational, highly technical, etc., for consistency in interactions and to ensure that every customer interaction is aligned with the brand identity.

In some embodiments, a location 110 in the system 100 can include at least one kiosk 190 in communication with the processing unit and providing an interface for customers in location 110 to interact with the digital assistant implemented by the digital assistant module 168. The kiosk 190 can for instance include a microphone configured to record an utterance of the customer and a speaker configured to emit a response to the utterance. In some embodiments, the kiosk 190 includes a monitor configured to display an avatar in interaction with the customer. The utterance recorded by the microphone can be transcribed into a text query by an automated speech recognition module implemented in the kiosk 190 in order to be transmitted as a text string to the processing unit 160 via communication devices of the kiosk 190 and of the processing unit 160, and/or the recorded utterance can be transmitted to the processing unit to be transcribed into a text query by an automated speech recognition module implemented in the digital assistant module 168. The digital assistant module 168 is configured to associate the customer query with one or more relevant assets 120 in location 110. As an example, the customer could utter that they are looking for brown flooring, prompting the digital assistant module 168 to look up in the database 164 references of corresponding relevant assets 120 corresponding to samples of brown flooring that are available in location 110. The digital assistant module 168 can further obtain the last known location of the relevant assets 120 associated with the query and prepare a response indicating the same to the customer, to be conveyed via the kiosk 190. In some embodiments, the digital assistant module 168 can be configured to retrieve relevant assets 120 that are not available in location 110 but may be available in a different location, and guide the customer to the different location. In some embodiments, the digital assistant module 168 is further configured to determine, in response to a customer query, that a customer could benefit from human support and/or that it is unable to process the query or retrieve relevant assets. In response to this determination, the digital assistant module 168 can be configured to send an alert to a staff device 170 requesting that a staff member assist the customer. In some embodiments, the digital assistant module 168 is configured, when requesting staff assistance, to hand over customer preferences and/or information to the staff device 170, ensuring personalized service.

In some embodiments, the application that can be installed on a customer device 180 is configured to allow for the customer device 180 to establish a connection to the processing unit 160 in order to allow a customer to interact with the digital assistant implemented by the digital assistant module 168 directly on their device 180. In some embodiments, the application and the digital assistant module 168 are configured such that an interaction initiated on the kiosk 190 can be continued in the customer device 180. As an example, this makes it possible for the digital assistant module 168 to guide the customer to the precise locations of the relevant assets 120 available within the location 110.

In some embodiments, the digital assistant module 168 is configured, through the customer device 180 or through the kiosk, to allow for the customer to check out an asset 120 to be carried outside of the location 110 without triggering an alert, and to allow for the customer to check in the asset 120 back at the location 110, thereby making it possible for customers, for instance, to take one or more samples home. In some embodiments, the checkin and/or checkout process can be implemented in the application and/or in the kiosk 190, and the application and/or the kiosk 190 can be configured, when an asset in checked out or in, to transmit a checkout or checkin message to the processing unit 160. In some embodiments, the digital assistant module 168 is configured, when an asset 120 is checked in or out, to update the status of the asset 120 in the database 164, thereby allowing the database to function as an inventory tracking system and ensuring, for instance, that the digital assistant module 168 does not retrieve assets 120 that have been checked out as relevant assets in response to a customer query. In some embodiments, the digital assistant module 168 is configured to obtain information about the customers including for instance their name and/or contact information before allowing the checkout process to complete, ensuring that staff can track the assets 120 movement and follow up with customers.

In some embodiments, the digital assistant module 168 is further configured to allow for customer support for customers that are not in a location 110, for instance through the application or through a website. The digital assistant module 168 can for instance be configured to support online customers by guiding them through the process of selecting, ordering, and managing assets 120, or by providing information about nearby locations 110 that have assets 120 relevant to the customer's needs in stock. In some embodiments, the digital assistant module 168 is configured to allow the customer to reserve one or more assets 120 at a location 110 for pickup. The digital assistant can serve as a virtual brand expert on the brands and distributors'website, helping users navigate product offerings and place sample orders efficiently. Customers can for instance interact with the digital assistant via text and/or voice, ensuring a seamless user experience. The digital assistant can guide customers through browsing, selecting, and purchasing assets 120 such as product samples. Once a customer has chosen an asset, the digital assistant can help them complete the order process, including payment and shipping options. Through its interaction with customers, the digital assistant can further capture valuable data about customer preferences and behaviour, which can help brands refine their marketing strategies and follow up on leads.

In some embodiments, the digital assistant module 168 is configured to receive images from the customer, for instance shown to a camera of the kiosk 190 or uploaded via the application or a website, in order to retrieve matching assets from the database. As an example, an image can include a colour or a pattern, and the digital assistant module 168 can be configured to scan a brand's product database to find similar or matching products. In some embodiments, the digital assistant module 168 is directly linked to brands and distributors websites, allowing the digital assistant to recommend available assets.

In some embodiments, the digital assistant module 168 can be configured to implement a platform designed to support professionals such as architects, designers, and contractors who manage multiple projects and need quick access to assets such as product samples. The digital assistant can be integrated into this platform to provide advanced assistance tailored to industry needs. As an example, the digital assustant can support industry professionels in searching for products, ordering samples, and managing large-scale orders across multiple brands. Unlike other platforms that serve as intermediaries, the platform can allow professionals to interact directly with brands through the digital assistant. This streamlines the process and allows for better customization of orders and services.

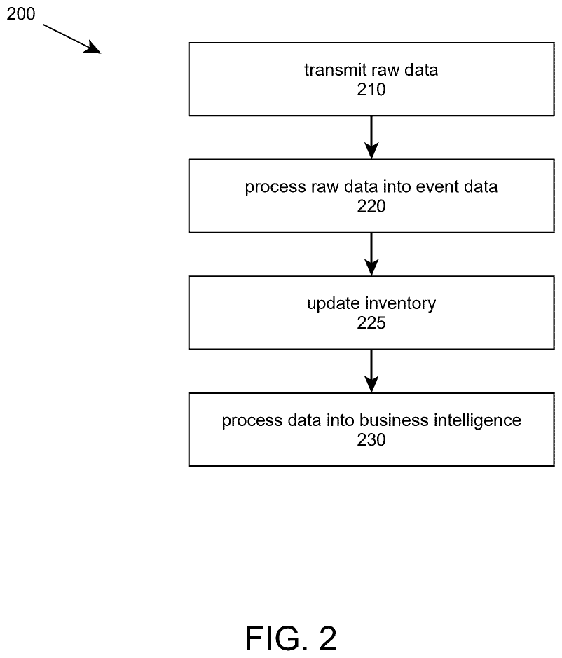

With reference to FIGS. 1 and 2, an exemplary method 200 for tracking a plurality of assets 120 is shown. Broadly described, tags 130 associated with assets 120 periodically transmit raw data 210, which are periodically processed into event data 220, which are themselves periodically processes to produce business intelligence 230.

As can be appreciated, each step can be performed periodically and simultaneously. In some embodiments, arrows in FIG. 2 do not correspond to a strict order in which steps are performed, but rather to data dependencies, i.e., that raw data transmitted in step 210 at any given time determines what event data can be generated in step 220 at the same given time, which in turns determines the business intelligence that can be produced in step 230 at the same given time.

In step 210, transmitters 234 of the tags 230 associated with each asset 220 in each location 110 transmits and/or broadcasts raw data, for instance including identifying data, periodically or continuously, for the receivers 140 to detect and forward to the processing unit 160. In some embodiments, the tags further transmit location information which is forwarded to the processing unit 160. In some embodiments, the receivers 140 measure a signal characteristic which is used to infer a position/location of the asset.

In step 220, the processing unit processes received raw data and/or location information to generate event data. In some embodiments, this includes accessing previously received and stored raw data and/or location data associated with one given asset 120 and identifying triggers that are defined to be associated with an onset of an event and with an offset of an event. As an example, raw data associated with a transmission that occurred immediately before an asset started moving can correspond to an event onset trigger. As another example, raw data associated with a transmission that occurred immediately after an asset stopped moving can correspond to an event offset trigger. As a further example, raw data associated with a final transmission that occurred with respect to a moving asset that then stopped transmitting correspond to an event offset trigger. When onset and offset triggers have been identifed in raw data associated with an asset 120, the raw data transmitted during the time period starting with the onset and ending with the offset can be aggregated into event data. In some embodiments, raw data associated with an event data and/or determined not to be associated with any event data can be removed from storage, for instance immediately when event data is generated or during a periodical cleanup process. In some embodiments, the processing unit 160 stores received raw data in a global database, e.g., in a data lake.

In some embodiments, in step 225, the location and/or the event data associated with an asset 120 is used to update an inventory database 164, which can subsequently be used by various modules of the processing unit 160 to determine which assets are available at any given location 110.

In step 230, the processing unit 160 processes event data to produce business intelligence, for instance using rule-based or machine learning systems. In some embodiments, event data associated with assets sharing a common SKU from different locations 110 are processed together to identify trends, for instance trends associated with a specific SKU. In some embodiments, locations 110 are grouped in regions, and event data associated with assets sharing a common SKU are processed together to identify regional trends associated with a specific SKU and a specific region. It can be appreciated that, as more event data becomes available to the processing unit 160, improved business intelligence can be produced. Therefore, step 230 can be performed continuously or periodically. In some embodiments, the business intelligence can be output via a display, and/or provided as part of a report.

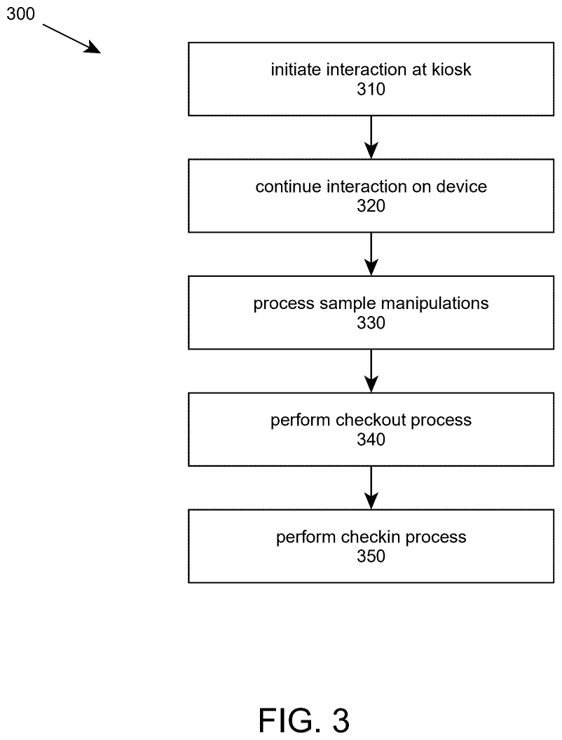

With reference to FIGS. 1 and 3, an exemplary method 300 for a customer to find and borrow a product sample 120 in a showroom 110 is shown. Broadly described, the customer can start interacting with a digital assistant 310 at a kiosk 190, continue 320 on their personal device 180, find and manipulate samples 120 generating event data 330, check a sample out 340, then check the sample back in 350.

In step 310, the customer in showroom 110 can make a query to a digital assistant at a kiosk 190. As an example, the customer may say what they are looking for, for instance brown flooring, or may show an image of a style, colour or pattern they are interested in. Based on the query, the kiosk will retrieve from the inventory database relevant samples that are in stock at the showroom and their kast known location and respond to the user, guiding them towards the last known location of the relevant samples.

In step 320, the customer can leave the vicinity of the kiosk 190 to find the relevant samples while continuing the interaction initiated at the kiosk 190 on an application running in their personal handheld device 180. For instance, the digital assistant can provide further guidance towards a given relevant sample, or provide guidance towards a next relevant sample, or allow for the customer to update or precise their query based on samples they have viewed.

In step 330, while the customer is manipulating samples 120, data is being generated and sent to a processing unit. Data can be sent by tags 130 attached to the samples 120 as well as by the customer device 180, making it possible for the processing unit to analyze the data into event data. As an example, in some embodiments, it will be possible to track the customer throughout the showroom 110, determine which samples 120 they manipulate and for how long, determine as examples whether they move certain samples 120 to other locations or pick two samples 120 at once to hold them side by side, and therefrom generate business intelligence.

In step 340, the customer can select a sample 120 that they want to check out in order to bring home. The checkout process can for instance include visiting the kiosk 190 with the desired sample 120. In some embodiments, because the location of the customer and of the sample are known, the kiosk 190 can automatically determine that the customer is holding a given sample while standing close near the kiosk and automatically initiate the checkout process. The checkout process can for instance include the customer providing personal information such as their name and/or their contact information at the kiosk. Once the sample is checked out, the inventory database can be updated to reflect that the sample is not available anymore.

When the checkout process is completed, the customer can leave the showroom 110 with the checked out sample 120 without triggering an alarm. Once the customer has perused the sample 120, they can bring it back to the showroom 110 and perform the checkin process in step 350. In some embodiments, because the location of the customer and of the sample are known once back in the showroom 110, it is possible for the checkin process to be performed automatically. Once the sample is checked back in, the inventory database can be updated to indicate that the sample is once again available.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A system for tracking a plurality of assets, the system comprising:
a plurality of tags, each asset from the plurality of assets having a tag from the plurality of tags affixed thereto, wherein each asset is associated with:
one zone of a site, and
one stock keeping unit (SKU) from a plurality of SKUs,
wherein each tag from the plurality of tags comprises a beacon from a plurality of beacons, the beacon being configured to broadcast from time to time a radio signal encoding raw data, resulting in the plurality of beacons broadcasting a plurality of radio signals, each radio signal encoding the raw data associated with a respective asset from the plurality of assets, the raw data comprising at least an identifier associated with the respective asset;
a plurality of gateways located in the site, each gateway comprising:
a receiver configured to receive the plurality of radio signals and to determine a signal characteristic of each of the plurality of radio signals,
a processor configured to extract the raw data encoded in each of the plurality of radio signals, and
a first communication device configured to transmit the raw data, the signal characteristic and a time associated with each of the plurality of radio signals; and
a processing unit, the processing unit comprising:
a second communication device configured to receive the raw data, the signal characteristic and the associated with each of the plurality of radio signals from the plurality of gateways,
an asset locator configured to compute a plurality of asset locations, each asset location being associated with a given asset from the plurality of assets and a given time, based at least on the signal characteristic associated with the given asset received from at least one gateway from the plurality of gateways,
an event processor configured to process a subset of the plurality of asset locations and the raw data received from the plurality of gateways associated with a given asset from the plurality of assets to generate event data,
a database configured to store the generated event data and the plurality of asset locations, and
a business analyzer configured to retrieve the event data from the database, to aggregate a subset of the event data related to a subset of the plurality of assets associated with a given SKU and to provide business intelligence related to the given SKU.

2. The system of claim 1, wherein the plurality of assets is a plurality of product samples and the site is a store or a retail showroom.

3. The system of claim 1, wherein each tag from the plurality of tags further comprises a movement sensor and is configured such that the beacon broadcasts a radio signal when a movement is detected by the movement sensor.

4. The system of claim 1, wherein the beacon is a Bluetooth™ Low Energy (BLE) beacon and the plurality of gateways comprises BLE antennae.

5. The system of claim 1, wherein the asset locator is further configured to detect whether a respective asset from the plurality of assets is outside a zone associated with the respective asset and, in response to detecting that the respective asset is outside the zone, to transmit a last asset position stored in the database, the system further comprising at least one staff device configured to received the last asset position and/or to display an alert.

6. The system of claim 1, further comprising a kiosk configured to allow for a conversation between a customer and a digital assistant, the kiosk comprising:
a microphone configured to record an utterance from the customer;
a speaker configured to emit a response to the utterance; and
a third communication device configured to transmit the utterance to the processing unit and to receive the response from the processing unit,
the processing unit further comprising a digital assistant module configured, in response to receiving the utterance, to:
convert the utterance to a query string using automatic speech recognition;
extract at least one relevant asset from the plurality of assets from the query string;
retrieve locations of the at least one relevant asset from the database; and
generate the response, the response comprising an indication of the locations of the at least one relevant asset.

7. The system of claim 6, further comprising a customer device configured to run an application, the application being configured to perform at least one of:
allowing for the conversation initiated at the kiosk to continue at the customer device; and
broadcasting additional signals encoding customer data.

8. The system of claim 7, wherein:
the application is configured to broadcast the additional signals;
the plurality of gateways are further configured to receive, decode and transmit the additional signals; and
the event processor is further configured to aggregate the raw data and the customer data to generate the event data.

9. The system of claim 6, wherein the kiosk is further configured to allow the customer to check out and check in a respective asset from the plurality of assets, wherein the third communication device is further configured, in response to the customer checking out or checking in the respective asset, to transmit a checkout message or a checkin message to the processing unit, wherein the processing unit is configured, in response to receiving the checkout message or the checkin message, to update the database to reflect a status of the respective asset.

10. The system of claim 1, comprising a plurality of additional sites each comprising a plurality of additional tracked assets generating additional event data, the processing unit being further configured for aggregating a subset of the additional event data related to a plurality of additional assets associated with the given SKU across the plurality of additional sites.

11. A method for tracking a plurality of assets, each asset from the plurality of assets being associated with one zone of a site and one stock keeping unit (SKU) from a plurality of SKUs, the method comprising:
broadcasting from time to time, by a tag from a plurality of tags, each asset from the plurality of assets having a tag from the plurality of tags affixed thereto, a radio signal encoding raw data, resulting in the plurality of tags broadcasting a plurality of radio signals, each radio signal encoding the raw data associated with a respective asset from the plurality of assets, the raw data comprising at least an identifier associated with the respective asset;
receiving, by at least one gateway from a plurality of gateways located in the site, the plurality of radio signals;
determining, by the at least one gatewat, a signal characteristic of each of the plurality of radio signals;
extracting, by the at least one gateway, the raw data encoded in each of the plurality of radio signals;
transmitting, by the at least one gateway, the raw data, the signal characteristic and a time associated with each of the plurality of radio signals;
receiving, by a processing unit, the raw data, the signal characteristic and the associated with each of the plurality of radio signals from the plurality of gateways;
computing, by the processing unit, a plurality of asset locations, each asset location being associated with a given asset from the plurality of assets and a given time, based at least on the signal characteristic associated with the given asset received from at least one gateway from the plurality of gateways;
processing, by the processing unit, a subset of the plurality of asset locations and the raw data received from the plurality of gateways associated with a given asset from the plurality of assets to generate event data;
storing, by the processing unit, the generated event data and the plurality of asset locations in a database; and
aggregating, by the processing unit, a subset of the event data related to a subset of the plurality of assets associated with a given SKU and to provide business intelligence related to the given SKU.

12. The method of claim 11, wherein the plurality of assets is a plurality of product samples and the site is a store or a retail showroom.

13. The method of claim 11, further comprising broadcasting by the tag a radio signal when a movement is detected by a movement sensor comprised in the tag.

14. The method of claim 11, wherein each tag comprises a Bluetooth™ Low Energy (BLE) beacon and the plurality of gateways comprises BLE antennae.

15. The method of claim 11, further comprising:
detecting, by the processing unit, whether a respective asset from the plurality of assets is outside a zone associated with the respective asset and, in response to detecting that the respective asset is outside the zone, to transmit a last asset position stored in the database to a staff device; and displaying, by the stagg device, an alert comprising an indication of the last one location.

16. The method of claim 11, further comprising allowing a conversation between a customer and a digital assistant at a kiosk, allowing the conversation comprising:
recording, by the kiosk, an utterance from the customer;
transmitting, by the kiosk, the utterance to the processing unit;
converting, by the processing unit, the utterance to a query string using automatic speech recognition;
extracting, by the processing unit, at least one relevant asset from the plurality of assets from the query string;
retrieving, by the processing unit, locations of the at least one relevant asset from the database;
generating, by the processing unit, a response, the response comprising an indication of the locations of the at least one relevant asset;
transmitting, by the processing unit, the response to the kiosk; and
emitting, by the kiosk, the response to the utterance.

17. The method of claim 16, further comprising performing, by an application running on a customer device, at least one of:
allowing for the conversation initiated at the kiosk to continue at the customer device; and
broadcasting additional signals encoding customer data.

18. The method of claim 17, further comprising:
broadcasting, by the application, the additional signals;
by the plurality of gateways, receiving, decoding and transmitting to the processing unit the additional signals; and
aggregating, by the processing unit, the raw data and the customer data to generate the event data.

19. The method of claim 16, further comprising:
allowing, by the kiosk, the customer to check out and check in a respective asset from the plurality of assets;
in response to the customer checking out or checking in the respective asset, transmitting, by the kiosk, a checkout message or a checkin message to the processing unit; and
in response to receiving the checkout message or the checkin message, updating, by the processing unit, the database to reflect a status of the respective asset.

20. The method of claim 11, wherein a plurality of additional sites each comprises a plurality of additional tracked assets generating additional event data, further comprising aggregating, by the processing unit, a subset of the additional event data related to a plurality of additional assets associated with the given SKU across the plurality of additional sites.
